(19) United States
(12) Patent Application Publication
(10) Pub. No.: US 2022/0146889 A1
(43) Pub. Date: May 12, 2022

(54) LIQUID CRYSTAL OPTICAL ELEMENT

(71) Applicant: Japan Display Inc., Tokyo (JP)

(72) Inventors: Junji KOBASHI, Tokyo (JP); Shinichiro OKA, Tokyo (JP); Yasushi TOMIOKA, Tokyo (JP); Koichi IGETA, Tokyo (JP)

(73) Assignee: Japan Display Inc., Tokyo (JP)

(21) Appl. No.: 17/515,903

(22) Filed: Nov. 1, 2021

(30) Foreign Application Priority Data
Nov. 6, 2020 (JP) 2020-185742
Jun. 11, 2021 (JP) 2021-097914

(51) Int. Cl. G02F 1/1337; G02F 1/137

(52) U.S. Cl. CPC G02F 1/133711; G02F 1/13718

(57) ABSTRACT

According to one embodiment, a liquid crystal optical element includes a substrate having a first surface, a plurality of structures disposed on the first surface and arranged at a predetermined pitch, and a liquid crystal layer surrounding each of the structures and interposed between the structures adjacent to each other. The liquid crystal layer has a larger thickness than the structure. The liquid crystal layer has liquid crystal molecules arranged along the structure, and is cured in a state in which an alignment direction of the liquid crystal molecules is fixed.

### CROSS-REFERENCE TO RELATED APPLICATIONS

This application is based upon and claims the benefit of priority from Japanese Patent Application No. 2020-185742, filed Nov. 6, 2020; and No. 2021-097914, filed Jun. 11, 2021, the entire contents of all of which are incorporated herein by reference.

### FIELD

Embodiments described herein relate generally to a liquid crystal optical element.

### BACKGROUND

For example, a liquid crystal polarizing grating using a liquid crystal material has been proposed. Such a liquid crystal polarizing grating divides incident light into zero order diffracted light and first order diffracted light when light having a wavelength λ is incident. When such a liquid crystal polarizing grating is realized, it is desired to increase productivity.

### BRIEF DESCRIPTION OF THE DRAWINGS

FIG. 1 is a cross-sectional view schematically illustrating a liquid crystal optical element 1 according to the present embodiment.

FIG. 2 is a plane view for explaining an alignment direction of first liquid crystal molecules LM1 in the vicinity of a first surface F1 of the liquid crystal optical element 1 illustrated in FIG. 1.

FIG. 3 is a view for explaining an example of a method for manufacturing the liquid crystal optical element 1 illustrated in FIG. 1.

FIG. 4 is a cross-sectional view schematically illustrating a first configuration example of the liquid crystal optical element 1.

FIG. 5 is a cross-sectional view schematically illustrating a second configuration example of the liquid crystal optical element 1.

FIG. 6 is a plane view schematically illustrating an example of an alignment pattern in a liquid crystal layer LC.

FIG. 7 is a plane view illustrating a first layout of a structure 20.

FIG. 8 is a plane view illustrating a second layout of the structure 20.

FIG. 9 is a plane view illustrating a third layout of the structure 20.

FIG. 10 is a plane view illustrating a fourth layout of the structure 20.

FIG. 11 is a plane view illustrating a fifth layout of the structure 20.

FIG. 12 is a plane view illustrating Modified Example 1.

FIG. 13 is a plane view illustrating Modified Example 2.

FIG. 14 is a plane view illustrating Modified Example 3.

FIG. 15 is a plane view illustrating Modified Example 4.

FIG. 16 is a plane view illustrating a sixth layout of the structure 20.

FIG. 17 is a plane view illustrating Modified Example 5.

FIG. 18 is a plane view illustrating Modified Example 6.

FIG. 19 is a plane view illustrating Modified Example 7.

FIG. 20 is a plane view illustrating Modified Example 8.

### DETAILED DESCRIPTION

In general, according to one embodiment, there is provided a liquid crystal optical element comprising a substrate having a first surface, a plurality of structures disposed on the first surface and arranged at a predetermined pitch, and a liquid crystal layer surrounding each of the structures and interposed between the structures adjacent to each other. The liquid crystal layer has a larger thickness than the structure. The liquid crystal layer has liquid crystal molecules arranged along the structure, and is cured in a state in which an alignment direction of the liquid crystal molecules is fixed.

Embodiments will be described hereinafter with reference to the accompanying drawings. The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

To make the descriptions easily understandable as needed, drawings illustrate X axis, Y axis and Z axis orthogonal to each other. A direction along the X axis is referred to as an X direction or the first direction, a direction along the Y axis is referred to as a Y direction or the second direction, and a direction along the Z axis is referred to as a Z direction or the third direction. A plane defined by the X axis and Y axis is referred to as an X-Y plane, and a plane defined by the X axis and Z axis is referred to as an X-Z plane. Viewing towards the X-Y plane is referred to as a planer view.

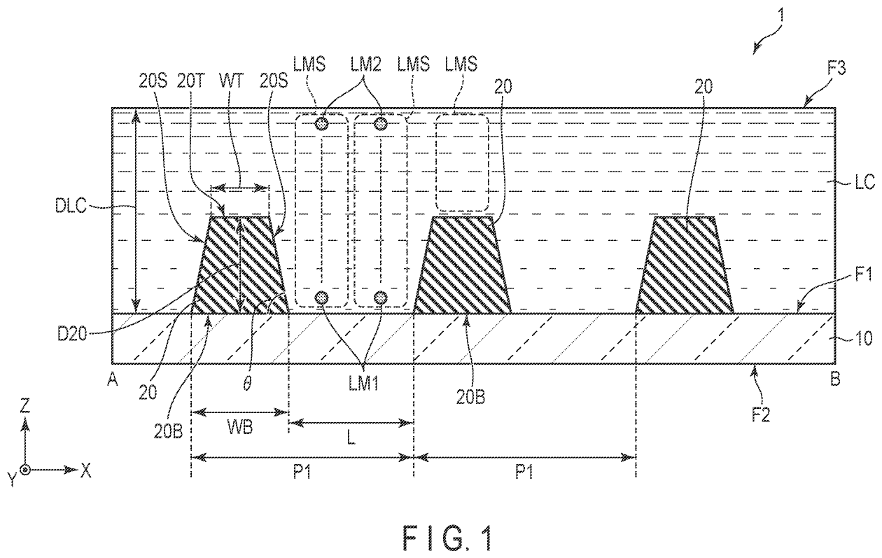

FIG. 1 is a cross-sectional view schematically illustrating liquid crystal optical element 1 according to the present embodiment. The liquid crystal optical element 1 includes a substrate 10, a plurality of structures 20, and a liquid crystal layer LC.

The substrate 10 is a transparent substrate that transmits light, and is formed of, for example, a transparent glass plate or a transparent synthetic resin plate. The substrate 10 may be formed of, for example, a transparent synthetic resin plate having flexibility. The substrate 10 can take any shape. For example, the substrate 10 may be curved. The refractive index of the substrate 10 is larger than the refractive index of air, for example.

In the present specification, “light” includes visible light and invisible light. For example, the lower limit wavelength of the visible light region is 360 nm or more and 400 nm or less, and the upper limit wavelength of the visible light region is 760 nm or more and 830 nm or less. The visible light includes a first component (blue component) in a first wavelength band (for example, 400 nm to 500 nm), a second component (green component) in a second wavelength band (for example, 500 nm to 600 nm), and a third component (red component) in a third wavelength band (for example, 600 nm to 700 nm). The invisible light includes an ultraviolet ray in a wavelength band shorter than the first wavelength band and an infrared ray in a wavelength band longer than the third wavelength band.

In the present specification, “transparent” is preferably colorless and transparent. However, “transparent” may be translucent or colored transparent.

The substrate 10 is formed in a flat plate shape along an X-Y plane, and has a first surface F1 and a second surface F2. The first surface F1 and the second surface F2 are approximately parallel to the X-Y plane, and are opposed to each other in a Z direction. The second surface F2 is, for example, in contact with air, but may be covered with another thin film.

The plurality of structures 20 are disposed on the first surface F1 and are arranged along an X direction at a predetermined first pitch P1. The structure 20 herein is a convex body extending in the Z direction from the first surface F1. Although described in detail later, the plurality of structures 20 have a function of defining an alignment direction of liquid crystal molecules included in the liquid crystal layer LC. Each of the structures 20 is in contact with the first surface F1, but another thin film may be interposed between the structure 20 and the first surface F1. The structure 20 is formed of, for example, an organic material, but may be formed of an inorganic material.

The structure 20 has a cross-sectional shape tapered along the Z direction on an X-Z plane. In other words, the structure 20 has a bottom portion 20B in contact with the first surface F1 and a top portion 20T opposite to the bottom portion 20B, and a width WB of the bottom portion 20B along the X direction is larger than a width WT of the top portion 20T. In the example illustrated in FIG. 1, the first surface F1 is exposed between the bottom portions 20B that are adjacent to each other. However, the first surface F1 between the bottom portions 20B adjacent to each other may be covered with a thin film.

In addition, the structure 20 has side surfaces 20S between the bottom portion 20B and the top portion 20T. The side surfaces 20S are opposed to each other in the X direction. Each of the side surfaces 20S is an inclined plane angled with respect to the Z direction.

In a configuration example in which the structure 20 is in contact with the substrate 10, the structure 20 has the same refractive index as the substrate 10. For this reason, light reaching an interface between the substrate 10 and the structure 20 is hardly refracted.

Each of the structures 20 has a substantially constant thickness D20 along the Z direction from the first surface F1. The thickness D20 of the structure 20 is larger than the width WB of the bottom portion 20B. For example, the thickness D20 is from 100 nm to 2000 nm, and desirably from 300 nm to 1000 nm. The width WB is, for example, from 50 nm to 1500 nm, and desirably from 100 nm to 1000 nm. A ratio of the width WB to the thickness D20 (WB/D20) is smaller than 1 and larger than 0.1.

An angle θ formed by the side surface 20S and the bottom portion 20B of the structure 20 is desirably smaller than 90°. For example, the angle θ is from 65° to 88°, and desirably from 75° to 85°.

The liquid crystal layer LC surrounds each of the structures 20 and is in contact with the top portion 20T and the side surface 20S. Moreover, in the example illustrated in FIG. 1, the liquid crystal layer LC is in contact with the first surface F1 between the structures 20 that are adjacent to each other. The liquid crystal layer LC has a thickness DLC along the Z direction from the first surface F1. The thickness DLC of the liquid crystal layer LC is larger than the thickness D20 of the structure 20. For example, the thickness DLC is from 1000 nm to 14000 nm, and desirably from 5000 nm to 12000 nm. The thickness D20 is as described above. A ratio of the thickness D20 to the thickness DLC (D20/DLC) is smaller than 1 and larger than 0.01. The ratio (D20/DLC) is desirably smaller than 1 and larger than 0.04.

The thickness DLC of the liquid crystal layer LC described here corresponds to the thickness of the liquid crystal layer LC as a single-layer body. Incidentally, the liquid crystal layer LC may be a multilayer body in which a plurality of layers is laminated.

A distance L between the bottom portions 20B of the structures 20 adjacent to each other along the X direction is smaller than the thickness DLC of the liquid crystal layer LC. For example, the distance L is from 50 nm to 1500 nm, and desirably from 100 nm to 1000 nm. The thickness DLC is as described above. A ratio of the distance L to the thickness DLC (L/DLC) is smaller than 1 and larger than 0.007. The ratio (L/DLC) is desirably smaller than 0.2 and larger than 0.014.

In addition, the distance L is equal to or smaller than the thickness D20. For example, a ratio of the distance L to the thickness D20 (L/D20) is 1 or less and larger than 0.3. Incidentally, from the viewpoint of defining the alignment direction of the liquid crystal molecules, the distance L is desirably small, and the thickness D20 is desirably large. However, in consideration of productivity in the case of forming the structure 20 by a manufacturing method using a mold to be described later, the distance L is desirably large, and the thickness D20 is desirably small.

In the example illustrated in FIG. 1, no other thin film or substrate overlaps the liquid crystal layer LC in the Z direction. In other words, the liquid crystal layer LC has a surface F3 in contact with air. Incidentally, the surface F3 may be covered with another thin film such as a protective film.

The liquid crystal layer LC includes a plurality of liquid crystal structures LMS. The liquid crystal structure LMS has first liquid crystal molecules LM1 located on one end side thereof and second liquid crystal molecules LM2 located on the other end side thereof. The first liquid crystal molecules LM1 are near to the first surface F1, and the second liquid crystal molecules LM2 are near to the surface F3.

The first liquid crystal molecule LM1 in each of the liquid crystal structures LMS is located between the structures 20 adjacent to each other in the X direction. The second liquid crystal molecule LM2 in each of the liquid crystal structures LMS is located above the structures 20 along the Z direction. In addition, the liquid crystal structure LMS is also located above the structure 20.

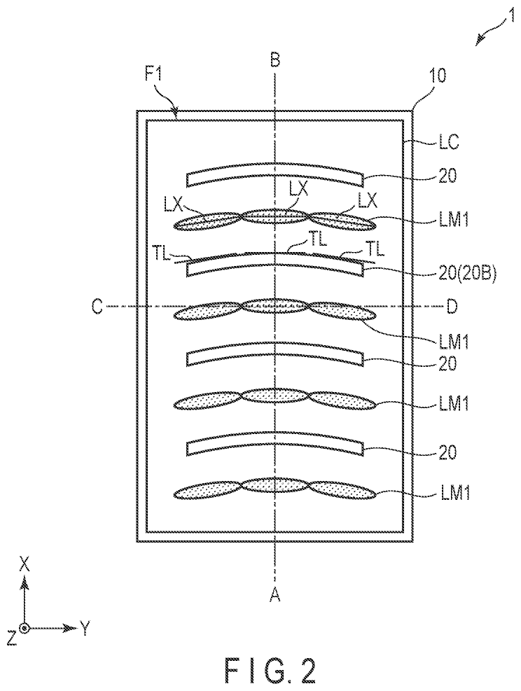

The alignment direction of the first liquid crystal molecule LM1 is defined by the adjacent structures 20. The relationship between the alignment direction and the structure 20 will be described later with reference to FIG. 2. Each of the liquid crystal structures LMS can be regarded as a continuous body in which a plurality of liquid crystal molecules including the first liquid crystal molecule LM1 and the second liquid crystal molecule LM2 are arranged in the Z direction. For this reason, the alignment direction of the first liquid crystal molecule LM1 is defined by the structure 20, whereby the alignment direction of the plurality of liquid crystal molecules that include the second liquid crystal molecule LM2 and are arranged in the Z direction is defined according to the alignment direction of the first liquid crystal molecule LM1. As a result, the plurality of liquid crystal molecules including the first liquid crystal molecule LM1 and the second liquid crystal molecule LM2 in each of the liquid crystal structures LMS are aligned in a predetermined direction on the X-Y plane.

The liquid crystal layer LC of the present embodiment is cured in a state in which the alignment direction of the liquid crystal molecules including the first liquid crystal molecule LM1 and the second liquid crystal molecule LM2 is fixed. In other words, the alignment direction of the liquid crystal molecules is not controlled according to an electric field. For this reason, the liquid crystal optical element 1 does not include an electrode for alignment control. Such liquid crystal layer LC is formed, for example, by polymerizing a monomer by applying energy such as light.

FIG. 2 is a plane view for explaining the alignment direction of the first liquid crystal molecules LM1 in the vicinity of the first surface F1 of the liquid crystal optical element 1 illustrated in FIG. 1. FIG. 1 corresponds to a cross-sectional view of the liquid crystal optical element 1 taken along line A-B illustrated in FIG. 2.

The plurality of structures 20 are formed so as to have approximately the same shape in planar view, and each are curved. The plurality of structures 20 are arranged spaced apart along the X direction. The first liquid crystal molecule LM1 between the structures 20 adjacent to each other in the X direction is cured in a state in which a major axis LX thereof is aligned along a tangent TL of the structure 20. The tangent TL herein is, for example, a tangent in contact with an outer edge of the bottom portion 20B of the structure 20.

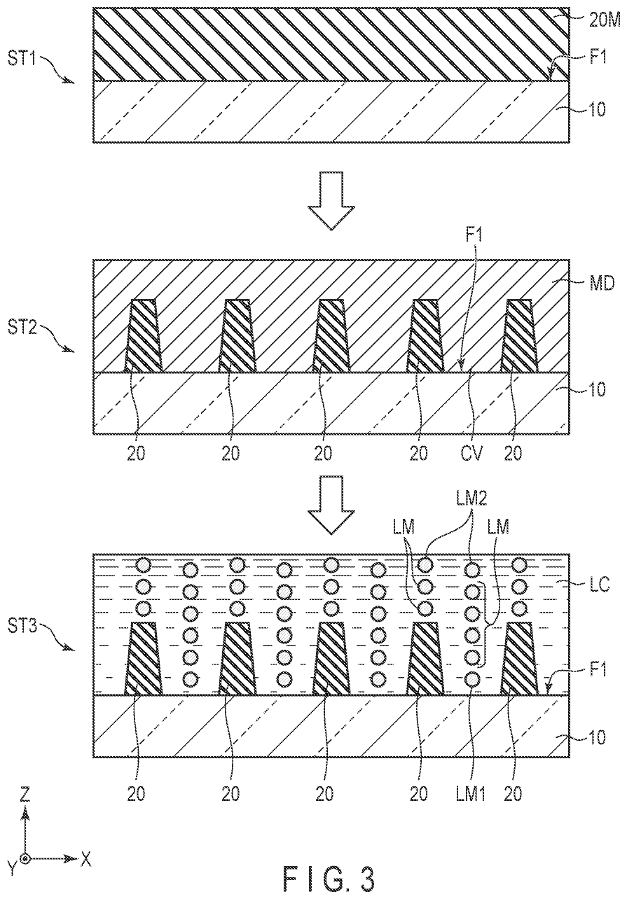

FIG. 3 is a view for explaining an example of a method for manufacturing the liquid crystal optical element 1 illustrated in FIG. 1.

First, in step ST1, a transparent structure material 20M is applied to the first surface F1 of the substrate 10, and a solvent is removed to form a state in which the structure material 20M is temporarily cured. Here, an ultraviolet curing resin is applicable as the structure material 20M.

Subsequently, in step ST2, a mold MD in which a concavity corresponding to the shape of the structure 20 is formed in advance is prepared, and the mold MD is superimposed on the structure material 20M and then irradiated with ultraviolet rays while being pressurized. As a result, the structure material 20M is cured into a shape corresponding to the concavity of the mold MD, and the structure 20 is thus formed. Thereafter, the mold MD is removed.

In the example illustrated in FIG. 3, ultraviolet rays are irradiated in a state in which convex portions CV of the mold MD are in contact with the first surface F1. For this reason, the formed structures 20 are spaced apart from each other, and the first surface F1 between the structures 20 is exposed.

Incidentally, when the mold MD is pressurized, ultraviolet rays may be irradiated in a state in which the structure material 20M is interposed between the convex portions CV and the first surface F1. In this case, the first surface F1 between the structures 20 is covered with a thin film of the same material as that of the structure 20.

Subsequently, in step ST3, the liquid crystal layer LC is formed on the substrate 10. The liquid crystal layer LC is formed, for example, in the following manner. First, a liquid crystal material is applied so as to be in contact with the first surface F1 and the structures 20. Then, the liquid crystal material is cured by irradiation with light such as ultraviolet rays to form the liquid crystal layer LC.

However, before the liquid crystal material is cured, the alignment direction of the liquid crystal molecules contained in the liquid crystal material is fixed as follows. That is, the first liquid crystal molecule LM1 near to the first surface F1 is horizontally aligned along the X-Y plane between the structures 20 adjacent to each other, and the major axis thereof is aligned along the tangent of the structure 20. The alignment direction of the liquid crystal molecules (including the second liquid crystal molecule LM2) LM overlapping in the Z direction with respect to the first liquid crystal molecule LM1 is determined according to the alignment direction of the first liquid crystal molecule LM1. The liquid crystal molecules LM located above the structures 20 are aligned following the liquid crystal molecules LM therearound.

In the example illustrated in FIG. 3, the alignment direction of the liquid crystal molecules LM overlapping the first liquid crystal molecule LM1 is substantially coincident with the alignment direction of the first liquid crystal molecule LM1, but when a chiral agent is added to the liquid crystal material, the plurality of liquid crystal molecules LM overlap in the Z direction while turning around at the first liquid crystal molecule LM1 as a starting point.

As described above, the alignment direction of each of the liquid crystal molecules LM is fixed according to the alignment direction of the first liquid crystal molecule LM1, and thereafter, the liquid crystal material is subjected to curing treatment.

According to the present embodiment, the minute structures 20 can be easily formed using the mold MD having minute uneven parts on the wavelength order. These structures 20 have a function of defining the alignment direction of the liquid crystal molecules contained in the liquid crystal material when the liquid crystal material is applied. The structure 20 has a pattern formed such that the liquid crystal molecules LM form a desired alignment pattern. For this reason, the liquid crystal material is cured in a state in which the alignment direction of each of the liquid crystal molecules is fixed in a predetermined direction, and the liquid crystal layer LC having a predetermined retardation is formed. Therefore, the liquid crystal optical element 1 having desired optical property can be mass-produced.

As an example, when a prototype of the liquid crystal optical element 1 is built by setting the width WB of the structure 20 to 150 nm, the distance L to 300 nm, and the thickness D20 to 300 nm, it has been confirmed that a liquid crystal layer LC having liquid crystal molecules aligned in a predetermined direction is formed and a desired retardation is obtained.

Next, a specific configuration example of the liquid crystal optical element 1 according to the present embodiment will be described.

### FIRST CONFIGURATION EXAMPLE

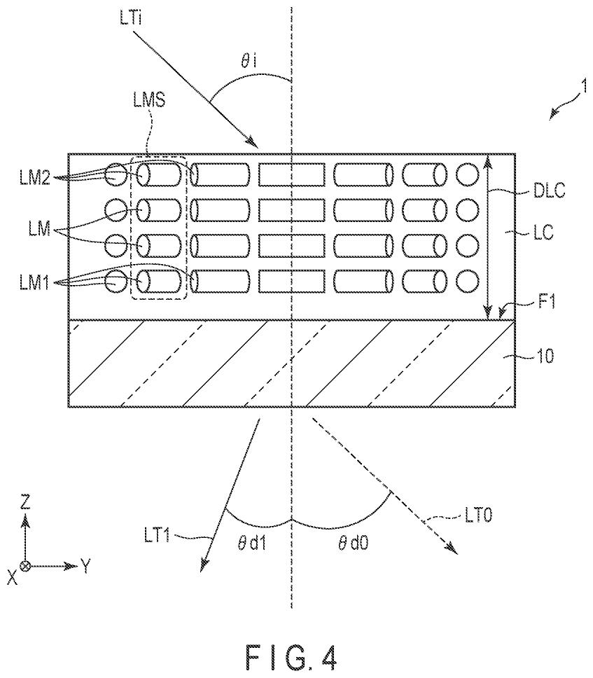

FIG. 4 is a cross-sectional view schematically illustrating a first configuration example of the liquid crystal optical element 1. FIG. 4 corresponds to a cross-sectional view of the liquid crystal optical element 1 taken along line C-D illustrated in FIG. 2. The first configuration example corresponds to an example in which the liquid crystal optical element 1 functions as a transmissive type diffraction grating. The liquid crystal layer LC has a nematic liquid crystal having a uniform alignment direction along the Z direction. The alignment direction of the plurality of first liquid crystal molecules LM1 arranged along the first surface F1 continuously changes along the Y direction.

Incidentally, when the liquid crystal layer LC is a multilayer body as described above, the liquid crystal layer LC may be a nematic liquid crystal in which liquid crystal molecules are partially aligned in a twisted manner.

When the refractive anisotropy or birefringence of the liquid crystal layer LC is An (difference between a refractive index ne of liquid crystal molecules for extraordinary light and a refractive index no of liquid crystal molecules for ordinary light), the thickness of the liquid crystal layer LC is DLC, and the wavelength of the diffracted light is λ, the retardation Δn·DLC of the liquid crystal layer LC is desirably λ/2.

Focusing on one liquid crystal structure LMS, the alignment direction of the first liquid crystal molecule LM1 and the alignment direction of the second liquid crystal molecule LM2 are substantially coincident with each other. In addition, the alignment direction of other liquid crystal molecules LM between the first liquid crystal molecule LM1 and the second liquid crystal molecule LM2 is also substantially coincident with the alignment direction of the first liquid crystal molecule LM1.

On the liquid crystal optical element 1, light may be incident from the liquid crystal layer LC side or from the substrate 10 side. Here, a case where light is incident from the liquid crystal layer LC side will be described. An incident light LTi is transmitted through the liquid crystal optical element 1, and then divided into zero order diffracted light LT0 and first order diffracted light LT1. A diffraction angle θd0 of the zero order diffracted light LT0 is equal to an angle of incidence θi of the incident light LTi. A diffraction angle θd1 of the first order diffracted light LT1 is different from the angle of incidence θi.

### SECOND CONFIGURATION EXAMPLE

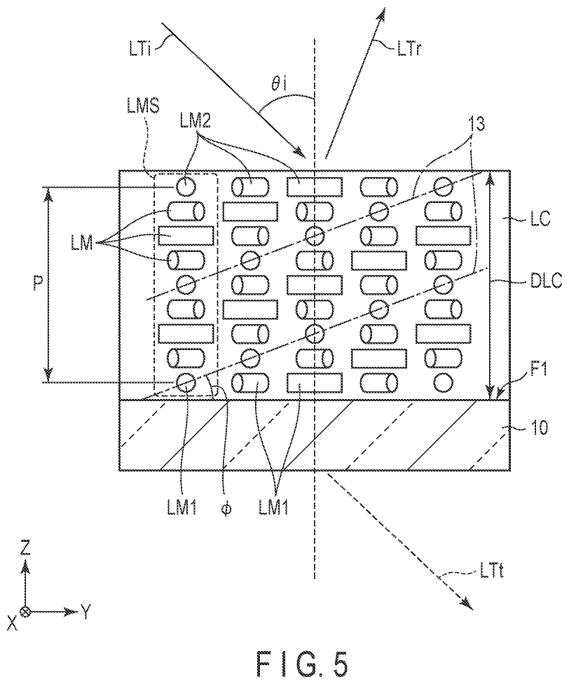

FIG. 5 is a cross-sectional view schematically illustrating a second configuration example of the liquid crystal optical element 1. FIG. 5 corresponds to a cross-sectional view of the liquid crystal optical element 1 taken along line C-D illustrated in FIG. 2. The second configuration example corresponds to an example in which the liquid crystal optical element 1 functions as a reflective type diffraction grating. The liquid crystal layer LC has a cholesteric liquid crystal. Incidentally, in FIG. 5, for simplification of the drawing, one liquid crystal molecule LM represents a liquid crystal molecule aligned the average alignment direction among the plurality of liquid crystal molecules located in the X-Y plane. The alignment direction of the plurality of first liquid crystal molecules LM1 arranged along the first surface F1 continuously changes along the Y direction.

Focusing on one liquid crystal structure LMS, the plurality of liquid crystal molecules LM is helically stacked along the Z direction while turning around. The alignment direction of the first liquid crystal molecule LM1 and the alignment direction of the second liquid crystal molecule LM2 are substantially coincident with each other. The liquid crystal structure LMS has a helical pitch P. The helical pitch P indicates a helical cycle (360°).

The liquid crystal layer LC has a plurality of reflective surfaces 13 as indicated by a one-dot chain line. For example, the plurality of reflective surfaces 13 are approximately parallel to each other. The reflective surface 13 is inclined with respect to the first surface F1 and has an approximately plane shape extending along one direction. The reflective surface 13 selectively reflects light LTr that is a part of the incident light LTi according to Bragg's law and transmits the other light LTt. The reflective surface 13 reflects the light LTr according to an inclination angle φ of the reflective surface 13 with respect to the first surface F1.

In the example illustrated in FIG. 5, the helical pitch P is illustrated as a distance along the Z direction between the first liquid crystal molecule LM1 and the second liquid crystal molecule LM2. From the viewpoint of improving reflectance on the reflective surface 13, the thickness DLC of the liquid crystal layer LC is desirably 5 times or more, and more desirably 10 times or more the helical pitch P.

The reflective surface 13 herein corresponds to a surface having a uniform alignment direction of the liquid crystal molecules LM or a surface having a uniform spatial phase (equiphase wave surface). Incidentally, the shape of the reflective surface 13 is not limited to the plane shape but may be a concave or convex curved surface shape without particular limitation. Alternatively, a part of the reflective surface 13 may be uneven, the inclination angle φ of the reflective surface 13 may not be uniform, or the plurality of reflective surfaces 13 may not be regularly aligned. The reflective surface 13 having any shape can be configured according to the spatial phase distribution of the liquid crystal structure LMS.

The cholesteric liquid crystal which is the liquid crystal structure LMS reflects circularly polarized light turning in the same direction as the turning direction of the cholesteric liquid crystal, of light having a predetermined wavelength λ included in a selective reflection band Δλ. For example, when the turning direction of the cholesteric liquid crystal is clockwise, of the light having the predetermined wavelength λ, clockwise circularly polarized light is reflected, and counterclockwise circularly polarized light is transmitted. Similarly, when the turning direction of the cholesteric liquid crystal is counterclockwise, of the light having the predetermined wavelength λ, counterclockwise circularly polarized light is reflected, and clockwise circularly polarized light is transmitted.

When the helical pitch of the cholesteric liquid crystal is denoted by P, the refractive index of the liquid crystal molecules for extraordinary light is denoted by ne, and the refractive index of the liquid crystal molecules for ordinary light is denoted by no, the selective reflection band Δλ of the cholesteric liquid crystal for perpendicularly incident light is generally represented by “no*P to ne*P”. Specifically, the selective reflection band Δλ of the cholesteric liquid crystal changes according to the inclination angle φ of the reflective surface 13, the angle of incidence θi, and the like with respect to the range of “no*P to ne*P”.

Incidentally, the liquid crystal layer LC may be a single-layer body or a multilayer body. When the liquid crystal layer LC is a multilayer body, liquid crystal layers having different helical pitches may be stacked, or liquid crystal layers having helically turning directions opposite to each other may be stacked. In addition, when the liquid crystal layer LC is a single-layer body, the helical pitch may continuously change.

### EXAMPLE OF ALIGNMENT PATTERN

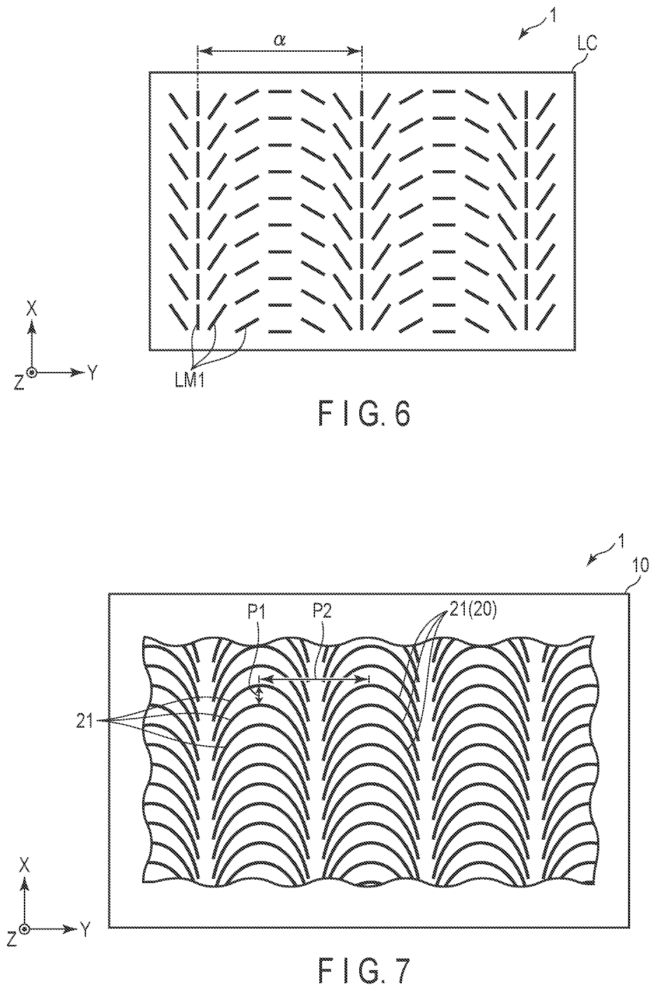

FIG. 6 is a plane view schematically illustrating an example of an alignment pattern in the liquid crystal layer LC. In FIG. 6, among the liquid crystal molecules contained in each of the liquid crystal structures, the alignment directions of the first liquid crystal molecules LM1 are illustrated, and the structure 20 is not illustrated.

The first liquid crystal molecules LM1 arranged along the Y direction are aligned in different directions from each other. In other words, the spatial phases in the X-Y plane are different along the Y direction. For example, the alignment direction of each of the first liquid crystal molecules LM1 changes by a certain angle along the Y direction (from left to right in the drawing). Here, the amount of change in the alignment direction of the first liquid crystal molecule LM1 is constant along the Y direction, but may gradually increase or gradually decrease. Here, as illustrated in FIG. 6, an interval between two first liquid crystal molecules LM1 obtained when the alignment direction of the first liquid crystal molecules LM1 arranged along the Y direction changes by 180° is defined as an alignment pitch α.

In contrast, the alignment directions of the first liquid crystal molecules LM1 arranged along the X direction are approximately coincident with each other. In other words, the spatial phases in the X-Y plane are approximately coincident with each other in the X direction.

For example, in a case where the liquid crystal optical element 1 functions as the transmissive type diffraction grating described with reference to FIG. 4, the alignment pitch α is set so as to satisfy the following relationship when the wavelength of the diffracted light is λ, the angle of incidence is θi, and the diffraction angle of the first-order diffracted light is θd1.

α=λ/(sin θd1−sin θi)

The alignment pitch a is, for example, 3 μm or less.

Next, a layout example of the structure 20 for realizing the alignment pattern illustrated in FIG. 6 will be described.

### First Layout

FIG. 7 is a plane view illustrating a first layout of the structure 20. The first layout corresponds to an example in which the plurality of structures 20 includes one type of structures (first structures) 21. Each of the structures 21 is similarly formed in a curved arch shape in planar view.

The plurality of structures 21 are arrayed in the X and Y directions. The plurality of structures 21 are arranged at the first pitch P1 along the X direction. In addition, the plurality of structures 21 are arranged along the Y direction at a second pitch P2 different from the first pitch P1. For example, the second pitch P2 is larger than the first pitch P1. The second pitch P2 is equal to the alignment pitch a illustrated in FIG. 6.

According to the first layout, the liquid crystal molecules between the structures 21 adjacent to each other in the X direction are aligned along the tangent of the structure 21, and the alignment direction of the liquid crystal molecules arranged in the Y direction continuously changes. The liquid crystal molecules between the structures 21 adjacent to each other in the Y direction are aligned along the X direction.

### Second Layout

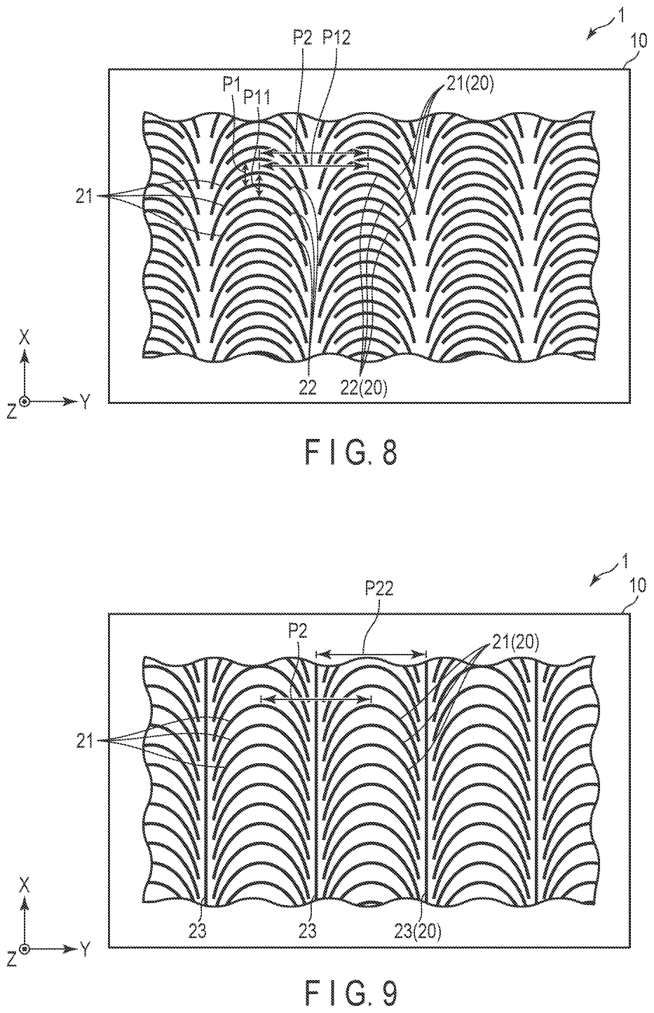

FIG. 8 is a plane view illustrating a second layout of the structure 20. The second layout corresponds to an example in which the plurality of structures 20 includes a plurality of types of structures (first structures) 21 and structures (second structures) 22. The second layout is different from the first layout in that the structures 22 are added. Each of the structures 22 has a different shape from the structure 21 in planar view and is formed in a curved arch shape.

The different shape herein includes a case where the structure 22 has a different overall length from the structure 21, a case where the structure 22 has a different curvature from the structure 21, and the like. In the example illustrated in FIG. 8, the structure 22 has a shorter overall length than the structure 21, but has the same curvature as the structure 21.

The plurality of structures 22 are arrayed in the X and Y directions. In the X direction, the structures 21 and 22 are alternately arranged. In addition, one structure 22 is disposed at a substantially intermediate point between two structures 21 adjacent to each other in the X direction. Incidentally, a plurality of structures 22 may be disposed between two structures 21 adjacent to each other in the X direction.

The plurality of structures 22 are arranged at a pitch P11 along the X direction. In addition, the plurality of structures 22 are arranged at a pitch P12 different from the pitch P11 along the Y direction.

For example, the pitch P11 is equal to the first pitch P1, the pitch P12 is equal to the second pitch P2, and the pitch P12 is equal to the alignment pitch α.

According to the second layout, the liquid crystal molecules between the structure 21 and the structure 22 that are adjacent to each other in the X direction are aligned along respective tangents of the structure 21 and the structure 22, and the alignment direction of the liquid crystal molecules arranged in the Y direction continuously changes. The liquid crystal molecules between the structures 21 adjacent to each other in the Y direction are aligned along the X direction.

### Third Layout

FIG. 9 is a plane view illustrating a third layout of the structure 20. The third layout corresponds to an example in which the plurality of structures 20 includes a plurality of types of structures (first structures) 21 and structures (third structures) 23. The third layout is different from the first layout in that the structures 23 are added. Incidentally, in the third layout, the structures 22 may be further added as in the second layout illustrated in FIG. 8.

Each of the structures 23 has a different shape from the structure 21 in planar view and linearly extends along the X direction. The structures 23 are each disposed between the structures 21 adjacent to each other in the Y direction. The plurality of structures 23 are arranged at a pitch P22 along the Y direction. For example, the pitch P22 is equal to the second pitch P2 and is equal to the alignment pitch a.

According to the third layout, the liquid crystal molecules between the structures 21 adjacent to each other in the X direction are aligned along the tangent of the structure 21, and the alignment direction of the liquid crystal molecules arranged in the Y direction continuously changes. The liquid crystal molecules between the structures 21 adjacent to each other in the Y direction are aligned along the structure 23.

Incidentally, in the third layout, the number of structures 23 located between the structures 21 adjacent to each other in the Y direction may be two or more.

### Fourth Layout

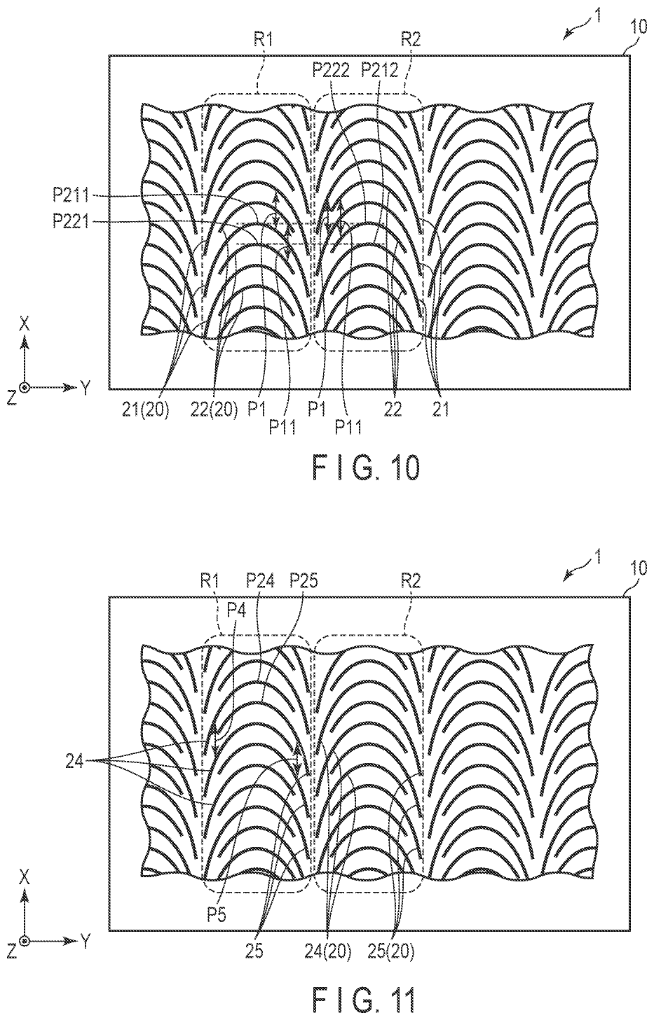

FIG. 10 is a plane view illustrating a fourth layout of the structure 20. The fourth layout corresponds to an example in which the plurality of structures 20 includes a plurality of types of structures (first structures) 21 and structures (second structures) 22. Both the structures 21 and 22 are formed in an arch shape as described in the second layout of FIG. 8. However, the fourth layout is different from the second layout in that in the structure row adjacent to each other in the Y direction, the structures 21 are arrayed while being shifted by a half period and the structures 22 are also arrayed while being shifted by a half period.

Here, structure rows R1 and R2 adjacent to each other in the Y direction are noted. In each of the structure rows R1 and R2, the structures 21 and 22 are alternately arranged along the X direction, and the structure 22 is located substantially in the middle of two structures 21 adjacent to each other in the X direction. In addition, in each of the structure rows R1 and R2, the plurality of structures 21 are arranged at the first pitch P1 along the X direction, and the plurality of structures 22 are arranged at the pitch P11 along the X direction.

An array period of the structures 21 and 22 in the structure row R1 is shifted by a half period from an array period of the structures 21 and 22 in the structure row R2. For this reason, a peak P211 of the structure 21 in the structure row R1 is arranged at a position of a peak P222 of the structure 22 in the structure row R2 in the Y direction. In addition, a peak 221 of the structure 22 in the structure row R1 is arranged at a position of a peak P212 of the structure 21 in the structure row R2 in the Y direction.

According to the fourth layout, the liquid crystal molecules between the structure 21 and the structure 22 that are adjacent to each other in the X direction are aligned along respective tangents of the structure 21 and the structure 22, and the alignment direction of the liquid crystal molecules arranged in the Y direction continuously changes. The liquid crystal molecules between the structure rows R1 and R2 adjacent to each other in the Y direction are aligned along the X direction.

### Fifth Layout

FIG. 11 is a plane view illustrating a fifth layout of the structure 20. The fifth layout corresponds to an example in which the plurality of structures 20 includes a plurality of types of structures (first structures) 24 and structures (second structures) 25. Each of the structures 24 and 25 is formed in an arch shape, but has a left-right asymmetric shape in the drawing. However, the shape of the structure 24 is line-symmetric with the shape of the structure 25 with respect to an axis parallel to the X direction. The structures 24 and 25 are alternately arranged along the X direction. The plurality of structures 24 are arranged at a pitch P4 along the X direction, and the plurality of structures 25 are arranged at a pitch P5 along the X direction.

In the structure 24, the length on the right side of the drawing is shorter than the length on the left side of the drawing around the position of the peak P24. In the structure 25, the length on the right side of the drawing is longer than the length on the left side of the drawing around the position of the peak P25.

According to the fifth layout, the liquid crystal molecules between the structure 24 and the structure 25 that are adjacent to each other in the X direction are aligned along respective tangents of the structure 24 and the structure 25, and the alignment direction of the liquid crystal molecules arranged in the Y direction continuously changes. The liquid crystal molecules between the structure rows R1 and R2 adjacent to each other in the Y direction are aligned along the X direction.

### MODIFIED EXAMPLE 1

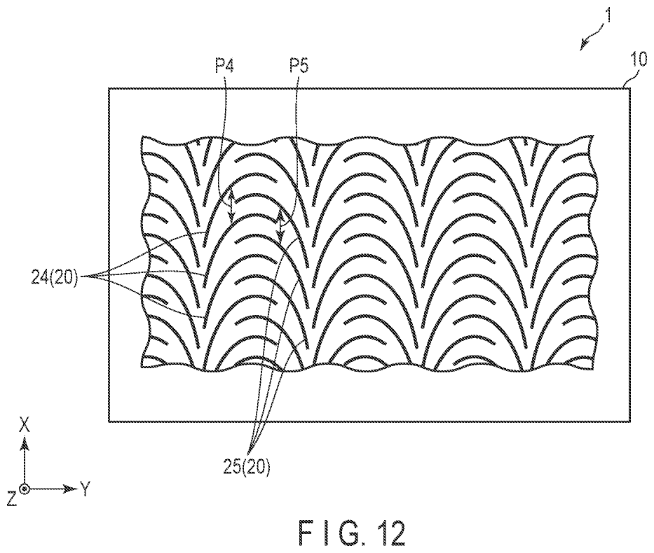

FIG. 12 is a plane view illustrating Modified Example 1.

Modified Example 1 illustrated here is different from the fifth layout illustrated in FIG. 11 in that the pitch P4 between the structures 24 along the X direction and the pitch P5 between the structures 25 along the X direction are enlarged.

### MODIFIED EXAMPLE 2

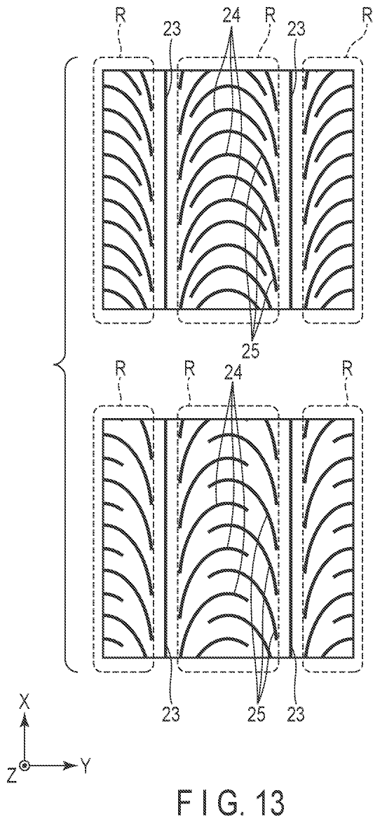

FIG. 13 is a plane view illustrating Modified Example 2.

The layout illustrated in the upper part of FIG. 13 corresponds to an example in which one structure 23 is added between adjacent structure rows R in the fifth layout illustrated in FIG. 11. As described above, the structure 23 extends linearly along the X direction.

The layout illustrated in the lower part of FIG. 13 corresponds to an example in which one structure 23 is added between the adjacent structure rows R in the layout of Modified Example 1 illustrated in FIG. 12.

### MODIFIED EXAMPLE 3

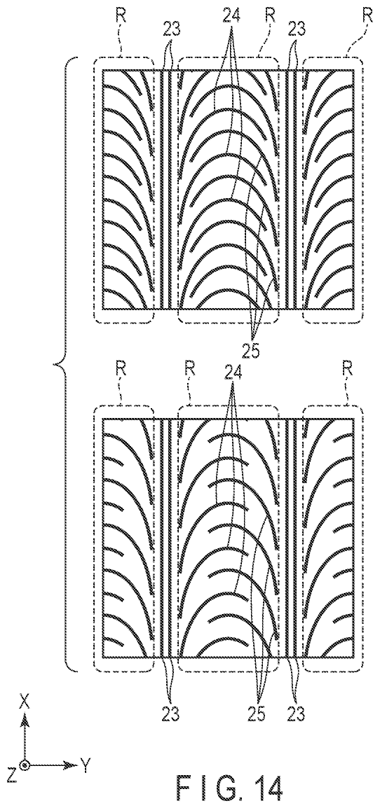

FIG. 14 is a plane view illustrating Modified Example 3.

The layout illustrated in the upper part of FIG. 14 corresponds to an example in which two structures 23 are added between the adjacent structure rows R in the fifth layout illustrated in FIG. 11. As described above, each of the structures 23 extends linearly along the X direction.

The layout illustrated in the lower part of FIG. 14 corresponds to an example in which two structures 23 are added between the adjacent structure rows R in the layout of Modified Example 1 illustrated in FIG. 12.

### MODIFIED EXAMPLE 4

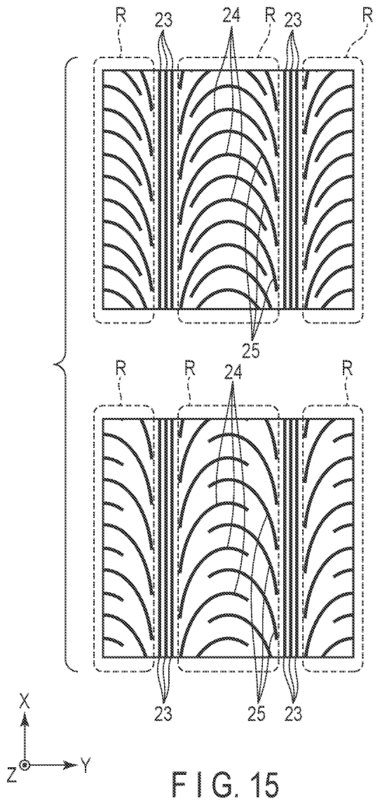

FIG. 15 is a plane view illustrating Modified Example 4.

The layout illustrated in the upper part of FIG. 15 corresponds to an example in which three structures 23 are added between the adjacent structure rows R in the fifth layout illustrated in FIG. 11.

The layout illustrated in the lower part of FIG. 15 corresponds to an example in which three structures 23 are added between the adjacent structure rows R in the layout of Modified Example 1 illustrated in FIG. 12.

The number of structures 23 positioned between the adjacent structure rows R may be 4 or more.

### Sixth Layout

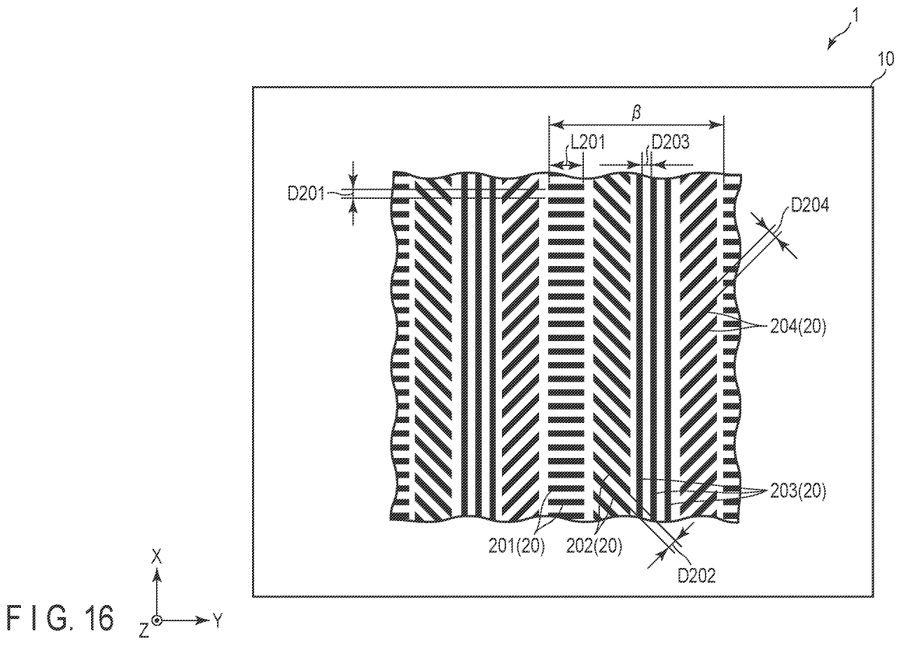

FIG. 16 is a plane view illustrating a sixth layout of the structure 20.

The sixth layout corresponds to an example in which the plurality of structures 20 includes N types of structures (first structures) 201, structures (second structures) 202, structures (third structures) 203, and structures (fourth structures) 204. Here, N is 4. Each of the structures 201 to 204 is linearly formed. However, the structures 201 to 204 extend in different directions from each other. The structures 201 to 204 are arranged spaced apart along the Y direction.

When the structures 201 to 204 are regarded as a group of structures, a repetition pitch (period) β of the structures is equal to the alignment pitch α described with reference to FIG. 6.

For example, when a group of structures is divided into N gradations and each gradation is reproduced by a linear structure, the extending direction of the structure of each gradation changes by an angle represented by (180°/N). In other words, an angle formed by the extending directions of the structures adjacent to each other in the Y direction is (180°/N).

The example illustrated here corresponds to a case where N is 4, and the extending directions of the structures 201 to 204 arranged in the Y direction change by 45° clockwise. Hereinafter, each of the structures 201 to 204 will be specifically described.

The plurality of structures 201 extend in the Y direction, are parallel to each other, and are arranged at an equal interval D201 along the X direction. The interval D201 is, for example, 100 nm. When the pitch β is 3 μm, the structure 201 has a length L201 of, for example, 600 nm along the Y direction.

The plurality of structures 202 are parallel to each other and arranged at regular intervals along the X direction. The extending direction of the structure 202 is a direction of 45° clockwise with respect to the structure 201 when the extending direction of the structure 201 is set as a reference. An interval D202 between the structures 202 adjacent to each other is, for example, 100 nm.

The plurality of structures 203 extend in the X direction, are parallel to each other, and are arranged at an equal interval D203 along the Y direction. In other words, the extending direction of the structure 203 is a direction of 90° clockwise with respect to the structure 201 when the extending direction of the structure 201 is set as a reference. The interval D203 between the structures 203 adjacent to each other is, for example, 100 nm.

The plurality of structures 204 are parallel to each other and arranged at regular intervals along the

X direction. The extending direction of the structure 204 is a direction of 135° clockwise with respect to the structure 201 when the extending direction of the structure 201 is set as a reference. An interval D204 between the structures 204 adjacent to each other is, for example, 100 nm.

According to the sixth layout, the liquid crystal molecules between the structures 201 adjacent to each other in the X direction are aligned along the extending direction of the structure 201, the liquid crystal molecules between the structures 202 adjacent to each other in the X direction are aligned along the extending direction of the structure 202, the liquid crystal molecules between the structures 203 adjacent to each other in the X direction are aligned along the extending direction of the structure 203, and the liquid crystal molecules between the structures 204 adjacent to each other in the X direction are aligned along the extending direction of the structure 204. Here, the case where N is 4 has been described, but N is an integer of 2 or more and may be an integer other than 4.

Some modified examples will be described below. Each modified example corresponds to the case where N is 4. In each modified example, the structures 201 to 204 extend in different directions. In the following description, the extending direction of the structure with respect to the Y direction is indicated as a direction of a clockwise angle θ with reference to the orientation of the tip of the arrow indicating the Y direction.

### MODIFIED EXAMPLE 5

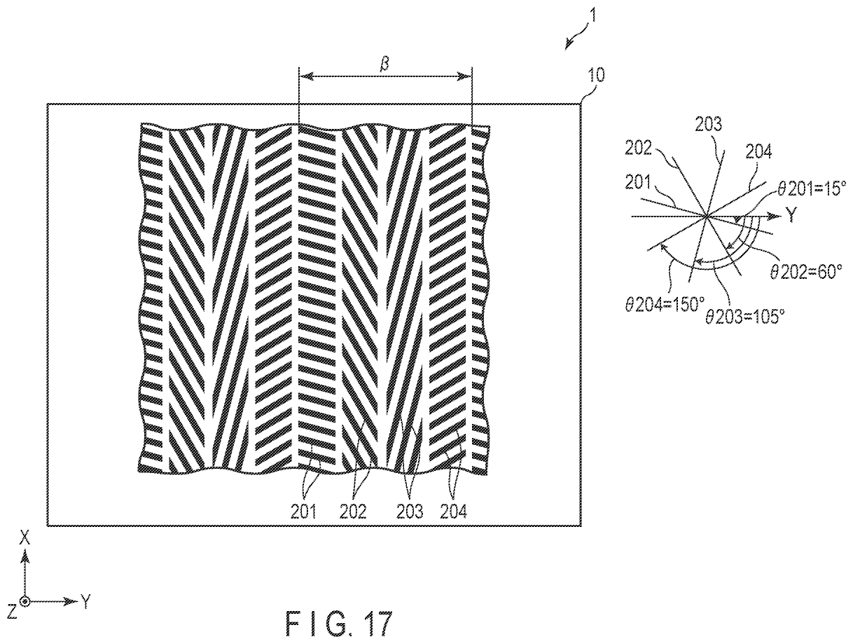

FIG. 17 is a plane view illustrating Modified Example 5.

The extending direction of the structure 201 with respect to the Y direction is a direction in which an angle θ201 is 15°. Similarly, the extending direction of the structure 202 is a direction in which an angle θ202 is 60°. The extending direction of the structure 203 is a direction in which an angle θ203 is 105°. The extending direction of the structure 204 is a direction in which an angle θ204 is 150°.

In other words, in Modified Example 5, none of the structures 201 to 204 extends in the Y and X directions.

In addition, a set of structures 201 and 202 is asymmetric with a set of structures 203 and 204 with respect to an axis passing through between the structures 202 and 203 and parallel to the X direction.

The angles formed by the extending directions of the structures adjacent to each other in the Y direction are all the same, namely 45°.

### MODIFIED EXAMPLE 6

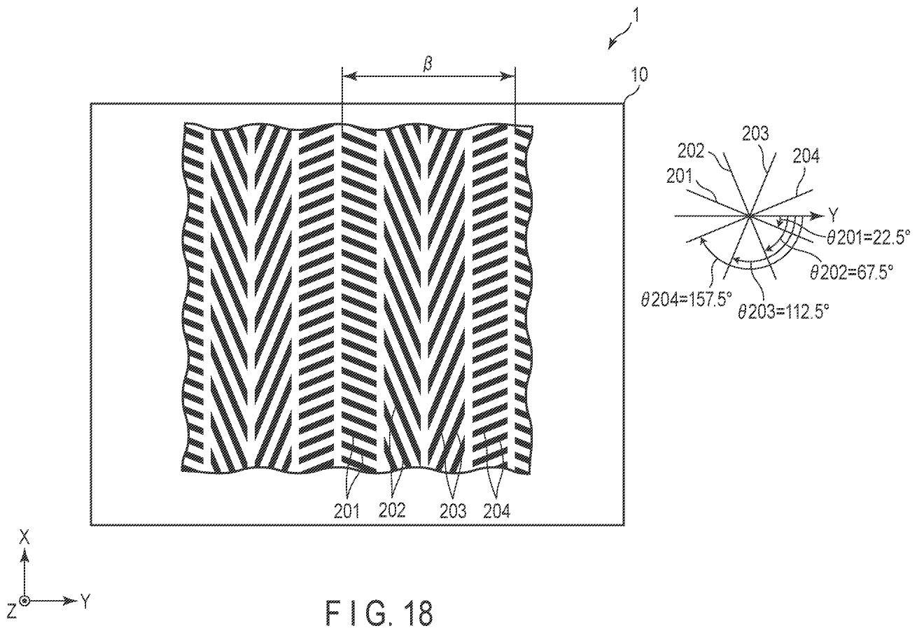

FIG. 18 is a plane view illustrating Modified Example 6.

The extending direction of the structure 201 with respect to the Y direction is a direction in which the angle θ201 is 22.5°. Similarly, the extending direction of the structure 202 is a direction in which the angle θ202 is 67.5°. The extending direction of the structure 203 is a direction in which the angle θ203 is 112.5°. The extending direction of the structure 204 is a direction in which the angle θ204 is 157.5°.

In addition, the set of structures 201 and 202 is line-symmetric with the set of structures 203 and 204 with respect to the axis passing through between the structures 202 and 203 and parallel to the X direction.

The angles formed by the extending directions of the structures adjacent to each other in the Y direction are all 45°.

### MODIFIED EXAMPLE 7

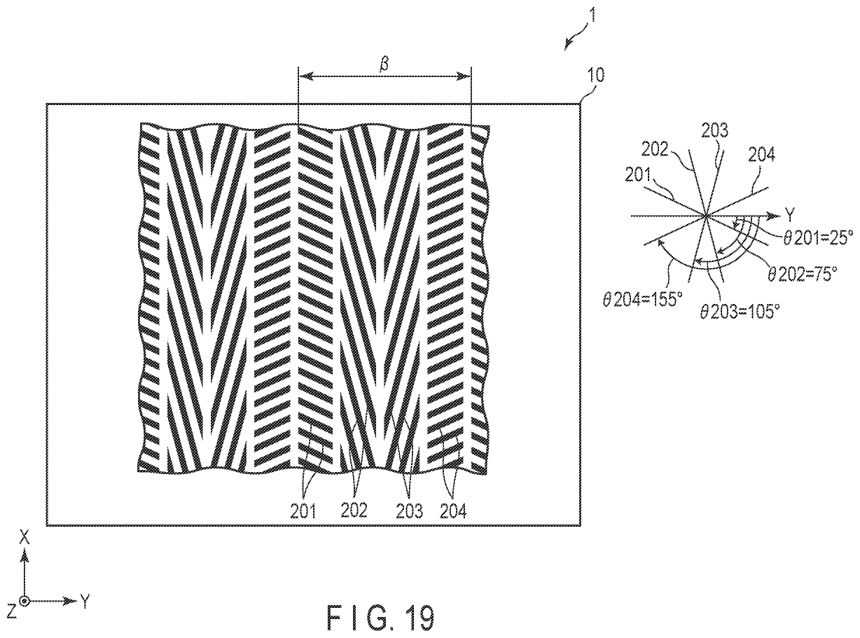

FIG. 19 is a plane view illustrating Modified Example 7.

The angles formed by the extending directions of the structures adjacent to each other in the Y direction are not necessarily constant.

That is, the extending direction of the structure 201 with respect to the Y direction is a direction in which the angle θ201 is 25°. Similarly, the extending direction of the structure 202 is a direction in which the angle θ202 is 75°. The extending direction of the structure 203 is a direction in which an angle θ203 is 105°. The extending direction of the structure 204 is a direction in which the angle θ204 is 155°.

The extending directions of the structures 201 and 202 intersect each other at 50°. The extending directions of the structures 202 and 203 intersect each other at 30°. The extending directions of the structures 203 and 204 intersect each other at 50°.

The extending directions of the structures 204 and 201 intersect each other at 50°.

### MODIFIED EXAMPLE 8

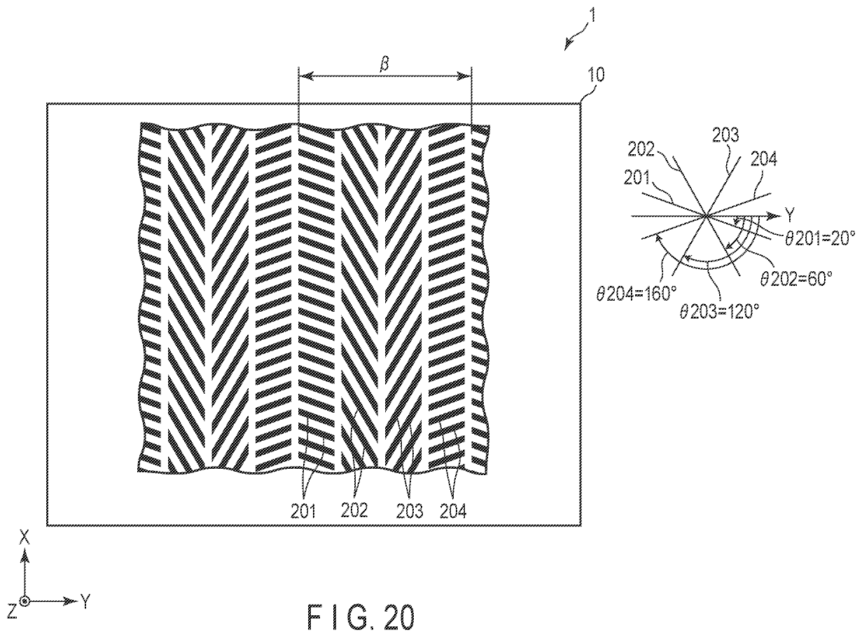

FIG. 20 is a plane view illustrating Modified Example 8.

The extending direction of the structure 201 with respect to the Y direction is a direction in which the angle θ201 is 20°. Similarly, the extending direction of the structure 202 is a direction in which the angle θ202 is 60°. The extending direction of the structure 203 is a direction in which the angle θ203 is 120°. The extending direction of the structure 204 is a direction in which the angle θ204 is 160°.

The extending directions of the structures 201 and 202 intersect each other at 40°. The extending directions of the structures 202 and 203 intersect each other at 60°. The extending directions of the structures 203 and 204 intersect each other at 40°. The extending directions of the structures 204 and 201 intersect each other at 40°.

As described in Modified Examples 7 and 8, the angles formed by the extending directions of the structures adjacent to each other in the Y direction are not necessarily a constant angle (180°/N). The angles presented here are merely illustrative and are not limited thereto.

As described above, according to the present embodiment, it is possible to provide a liquid crystal optical element capable of being mass-produced. While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal optical element comprising:
a substrate having a first surface;
a plurality of structures disposed on the first surface and arranged at a predetermined pitch; and
a liquid crystal layer surrounding each of the structures and interposed between the structures adjacent to each other,
wherein the liquid crystal layer has a larger thickness than the structure, and
the liquid crystal layer has liquid crystal molecules arranged along the structure, and is cured in a state in which an alignment direction of the liquid crystal molecules is fixed.

2. The liquid crystal optical element according to claim 1, wherein the structure is formed of a transparent organic material, and comprises a bottom portion in contact with the first surface and a top portion opposite to the bottom portion, and
the bottom portion has a larger width than the top portion.

3. The liquid crystal optical element according to claim 2, wherein the structure has a same refractive index as the substrate.

4. The liquid crystal optical element according to claim 2, wherein the thickness of the structure is larger than the width of the bottom portion.

5. The liquid crystal optical element according to claim 2, wherein a distance between the bottom portions of the structures adjacent to each other is smaller than the thickness of the liquid crystal layer.

6. The liquid crystal optical element according to claim 2, wherein a distance between the bottom portions of the structures adjacent to each other is equal to or smaller than the thickness of the structure.

7. The liquid crystal optical element according to claim 2, wherein each of the structures is curved in planar view, and
the liquid crystal molecules located between the structures adjacent to each other each have a major axis aligned along a tangent of the structure.

8. The liquid crystal optical element according to claim 1, wherein the structures comprise a plurality of first structures having a curved shape, and
the first structures are arranged at a first pitch along a first direction, and are arranged at a second pitch different from the first pitch along a second direction intersecting the first direction.

9. The liquid crystal optical element according to claim 8, wherein the structures further comprise a second structure disposed between the first structures adjacent to each other in the first direction, and
the second structure has a different shape from the first structure and is curved.

10. The liquid crystal optical element according to claim 8, wherein the structures further comprise at least a third structure disposed between the first structures adjacent to each other in the second direction, and
the third structure linearly extends along the first direction.

11. The liquid crystal optical element according to claim 1, wherein the liquid crystal layer comprises a nematic liquid crystal having a uniform alignment direction.

12. The liquid crystal optical element according to claim 1, wherein the liquid crystal layer comprises a cholesteric liquid crystal.

13. The liquid crystal optical element according to claim 8, wherein the structures further comprise a second structure disposed between the first structures adjacent to each other in the first direction, and
a shape of the first structure is line-symmetric with a shape of the second structure with respect to an axis parallel to the first direction.

14. The liquid crystal optical element according to claim 1, wherein the structures comprise N types of structures, and
the N types of structures are linearly formed and extend in different directions from each other, and
an angle formed by extending directions of mutually adjacent structures among the N types of structures is (180°/N).

15. The liquid crystal optical element according to claim 1, wherein the structures comprise a plurality of first structures arranged at regular intervals along a first direction; a plurality of second structures arranged at regular intervals along the first direction; and a plurality of third structures arranged at regular intervals along the first direction,
the first structure, the second structure, and the third structure are each linearly formed, extend in different directions from each other, and are sequentially arranged along a second direction intersecting the first direction, and
an angle formed by an extending direction of the first structure and an extending direction of the second structure is equal to an angle formed by the extending direction of the second structure and an extending direction of the third structure.

16. The liquid crystal optical element according to claim 1, wherein the structures comprise a plurality of first structures arranged at regular intervals along a first direction; a plurality of second structures arranged at regular intervals along the first direction; and a plurality of third structures arranged at regular intervals along the first direction,
the first structure, the second structure, and the third structure are each linearly formed, extend in different directions from each other, and are sequentially arranged along a second direction intersecting the first direction, and
an angle formed by an extending direction of the first structure and an extending direction of the second structure is different from an angle formed by the extending direction of the second structure and an extending direction of the third structure.
